(19) United States
(12) Patent Application Publication
(10) Pub. No.: US 2003/0023950 A1
(43) Pub. Date: Jan. 30, 2003

(54) Methods and apparatus for deep embedded software development

(76) Inventors: Wei Ma, Castro Valley, CA (US); Kiak Wei Khoo, Union City, CA (US)

Correspondence Address: John S. Beulick, Armstrong Teasdale LLP, Suite 2600, One Metropolitan Square, St. Louis, MO, 63102-2740, US

(21) Appl. No.: 09/757,831

(22) Filed: Jan. 10, 2001

(51) Int. Cl. G06F 9/44

(52) U.S. Cl. 717/102

(57) ABSTRACT

One embodiment of the present invention is a method for producing deep embedded software suitable for a target processor. The method includes steps of: authoring a behavioral model from a specification; authoring a structural model using the behavioral model; authoring a logical model using the structural model; and authoring a physical model using the logical model.

### COPYRIGHT NOTICE

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

### BACKGROUND OF THE INVENTION

This invention relates generally to manual and automatic methods for developing software that is closely linked with a processor (i.e., deep embedded software), and more particularly to a development and debugging process using a sequence of models particularly suited for efficient production of such software.

As transistor sizes are reduced to very deep sub-micron (VDSM) range, the costs of interconnectivity for interconnect-based chip design methodologies currently in use exceeds the economic benefit of smaller feature size. To compensate, a “memory+processor core” design paradigm is emerging, especially for system-on-a-chip (SOC) implementations. It is expected that, in the future, a very large portion of the functions of silicon chips will be realized by embedded software. The silicon estate will be used mostly for various memories (for example, RAM, ROM, and flash memory) that store the embedded software. Therefore, software optimization and memory size reduction is critical to the reduction of cost and dissipated power of semiconductor chips.

Digital Signal Processors (DSPs) are the typical example of applying embedded computing and software to replace analog components. In today's SOC chip design environment, embedded software development has already occupied more than 50% of effort. Among them, deep embedded software, such as DSP firmware, is the most difficult part and consumes the most of power due to its math intensive and repetitive execution natures.

The electronics industry, after having years of success producing personal computers (PC), is now beginning to produce “gadgets” with standalone embedded information appliances (IA). A distinguishing feature of information appliances as opposed to personal computers is that, in information appliances, system resources such as memory are not shared by many applications. Instead, each embedded system is focused on one or a few applications. Therefore, optimization of system resources is critical, and this optimization requires highly optimized and lower power consumption embedded software. Thus, development of embedded software is relatively difficult and expensive, and its unique requirements differ from either those of pure software or pure hardware.

It would thus be desirable to provide suitable firmware-oriented design environments for the design of embedded software. Known computer-aided design (CAD) tools do not provide such environments. Currently, developers of embedded software use either hardware design tools or pure software development tools to develop embedded software. These environments are inefficient for use in this manner, and their use often results in buggy, low performance systems.

Referring to FIG. 17, two known development methods include a compiler and optimization (CAO) technique 44 and an assembler and debug (AAD) technique 46. Each technique 44, 46 starts from a specification 48, from which a high level language (HLL) program 50 is produced. CAO technique 44 uses HLL program 50 and a high-level language compiler 52 to generate code 54, with manual optimization 56 performed on key modules. However, compilers 52 tend to produce output code 54 that is very inefficient for many important applications, including, for example, digital signal processing (DSP) applications. In addition, manual optimization 56 can be a lengthy process that is very difficult to manage. The resulting code is processed by an assembler 58 and tested utilizing a test engine or platform 60. The results are debugged and verified 62.

AAD technique 46 relies upon manual coding 64 to produce assembly language software 66 in assembly language. Software 66 is assembled using an assembler 58 and debugged in a test simulator 60, which may include an emulator 68. More optimized code can often be produced using AAD technique 46 rather than CAO technique 44. However, debugging process 62 is still very time consuming and better-suited for small applications rather than for SoC applications.

It would therefore be desirable to provide methods for efficiently producing and debugging deep embedded software, i.e., software closely associated with processors in SoCs.

### BRIEF SUMMARY OF THE INVENTION

There is therefore provided, in one embodiment of the present invention, a method for producing deep embedded software suitable for a target processor. The method includes steps of: authoring a behavioral model from a specification; authoring a structural model using the behavioral model; authoring a logical model using the structural model; and authoring a physical model using the logical model.

Embodiments of the present invention are applicable in developing highly optimized software code, especially software code deeply embedded in semiconductor chips. Embodiments of the present invention can significantly increase the productivity of programmers developing embedded software and reduce development cycle times of complex SOCs (systems-on-chips). Embodiments of the present invention facilitate the generation, debugging, and verification of software and firmware for Digital Signal Processors (DSPs), microprocessors, microcontrollers and other computational engines in electronic systems. Also, embodiments of the present invention permit step-by-step incremental verification that facilitates the development of deep embedded software.

### BRIEF DESCRIPTION OF THE DRAWINGS

FIG. 1 is a simplified representation of an system on a chip (SOC) embodiment of the present invention, showing a plurality of levels of design granularity.

FIG. 2 is an alternative representation of the SoC of FIG. 1 in which interrelationships and interactions between up embedded software (UES) and deep embedded software (DES) are broadly illustrated.

FIG. 3 is a procedural flow chart of one embodiment of a DES development method of the present invention.

FIG. 4 is a listing of an exemplary behavioral model.

FIGS. 5-7 contain a listing of an exemplary structural model corresponding to the behavioral model of FIG. 4.

FIGS. 8-10 contain a listing of an exemplary logical model corresponding to the structural model of FIGS. 5-7.

FIGS. 11-14 contain a listing of an exemplary physical model corresponding to the logical model of FIGS. 8-10.

FIG. 15 is an embodiment of a development tool of the present invention.

FIG. 16 is an embodiment of the present invention useful for systematically transferring assembly language code from one processor to another.

FIG. 17 is a diagrammatic representation of two known prior art firmware development methods.

### DETAILED DESCRIPTION OF THE INVENTION

As an aid in understanding acronyms used throughout this description, the following glossary is provided:

CAD: Computer Aided Design

DSP: Digital Signal Processing or Digital Signal Processor

EDA: Electronic Design Automation

Embedded Software: Software stored in a single chip (or a small group of chips as computer core) that will run applications software.

Deep Embedded Software (DES): embedded software that is very closely linked to hardware. They are normally written in assembly language or microcode to directly control hardware.

Up Embedded Software (UES): embedded software that is very closely associated with user applications. UES is normally written in a high-level language (for example, C++ or Java) that does not directly control hardware, but relies instead upon calls to the operating systems (OS).

Firmware: an embedded software that is stored in ROM (Read Only Memory) or Flash Memory. Firmware is almost the same as embedded software in today's technology.

SOC: System-On-a-Chip, a technology that integrates a whole system onto a single chip.

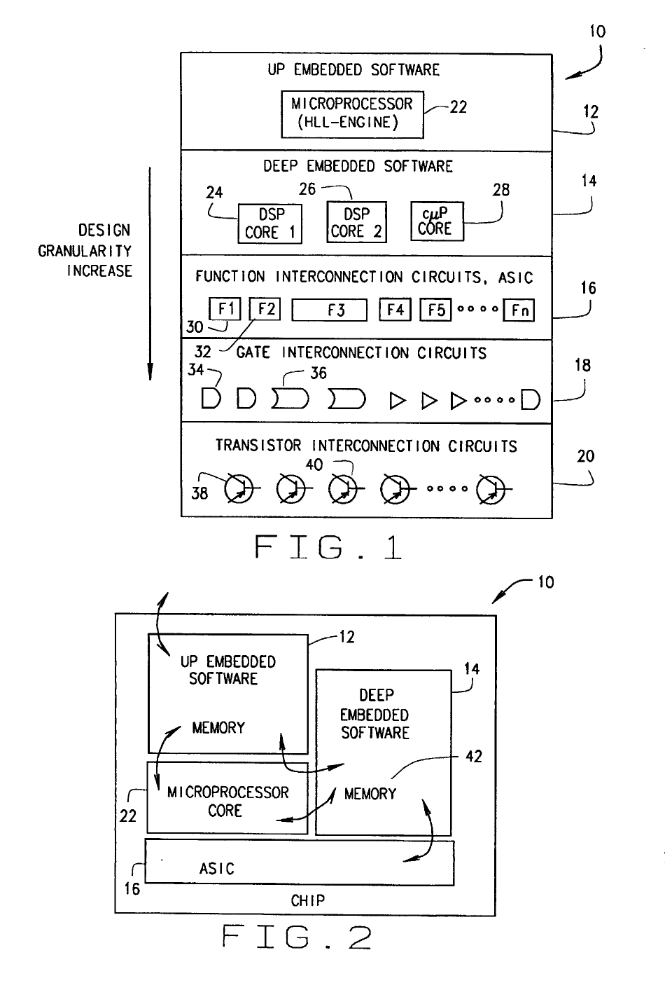

In one embodiment of the present invention and referring to FIG. 1, two types of embedded software, namely, up-embedded software (UES) and deep embedded software (DES), are treated differently. An exemplary single chip embodiment 10 of the present invention is realized in a design having different “base units” of different granularity. Looked upon from one point of view, any single processor with software can perform the functions of embodiment 10 if that single processor is fast enough. However, systems on a chip (SoCs) can be realized by designs having more than one of these different levels of granularity, and most SoCs will utilize all of these levels to some degree. For example, one exemplary SoC embodiment 10 represented in FIG. 1 uses up embedded software 12, deep embedded software 14, function interconnection circuits or ASIC functional blocks 16, gate interconnection circuits 18, and transistor interconnection circuits 20.

SoC 10 for example, utilizes four processors. A first processor 22 is a microprocessor used as a high-level language (HLL) engine to execute UES 12. Processor 22 executes code generated from HLL, such as C or Java. This is the least “granular” design component of chip 10, in that it has the largest base unit (microprocessor 22). UES 12 executes on processor 22 and controls interchip and interactive functions. In many embodiments, UES 12 is decision or branching intensive and quite large (e.g., measured in megabytes of code). Also in many embodiments, processor 22 does not consume large amounts of power to execute UES 12. UES 12 in many embodiments is relatively easy to develop and verify.

SoC 10 also includes low level language (LLL) engines 24, 26, and 28, in DES design component 14. DES design component 14 is somewhat more granular in design than UES design component 12, in that it uses somewhat smaller components. For example, in one embodiment, DES design component 14 comprises LLL engines 24, 26, and 28 that run assembly language code or microcode. More particularly, embodiment 10 utilizes two DSP cores 24, 26, and a configurable microprocessor or DSP core 28. DES software 14 resides on SoC chip 10 as embedded software that controls a processor core or cores (e.g., 24, 26 and 28) in the same chip to perform required functions. DES software 14 in many embodiments performs computationally intensive, intrachip and ASIC functions, and is repetitive and numerically intensive. In many embodiments, DES software is small (i.e., measured in kilobytes or a few hundred kilobytes), and its execution dominates the power consumption of SoC chip 10. DES software 14 in many embodiments is difficult software to develop and verify, as it is close to the circuit design level.

Below the DES design component 14 level, the design granularity increases, i.e., the base units get smaller. However, there is no software being executed at these lower levels. These lower levels comprise function interconnection circuits or ASIC functional blocks 16, which have many hardwired functional blocks such as 30, 32, etc. These functional blocks are designed by connecting circuits, so there is no accompanying software for execution at this level. The gate interconnection circuit level 18 includes interconnection based basic gates 34, 36, etc., which also need no software. Transistor interconnection circuit portion 20 includes individual interconnection-based transistors 38, 40, etc. Again, no software is required at this level.

Referring to FIGS. 1 and 2, UES in processor 22 manages application and link control functions that interface with inter-chip functions. DES in processor 24, 26, and/or 28 controls intra-chip functions such as circuit control and numerical processing. Memory 42 is constructed at a transistor level 20 as dictated by its regularity and density requirements. Core hardware of SoC 10 is constructed at gate level 18 and at functional interconnection or ASIC level 16. ASIC level 16 is constructed at a functional level using a circuit synthesizer tool (not shown).

Examples of UES 12 include, but are not limited to, man-machine interface (MMI) software, operating system (OS) software, communication protocol software, and application software. UES 12 is similar to non-embedded software, so that a pure software development method can be applied, because UES is largely comprised of decision intensive software that is relative easy to compile automatically. Usually, UES is also relatively large, so that compiler type code generating tools are required for efficient development.

Examples of DES 14 include, but are not limited to, audio/video compression software, encryption software, channel coding software, and modulation, equalization and other DSP software. DES 14 usually involves high complexity and differs from UES 12 in that DES 14 performance greatly affects chip performance, including power and/or speed. DES 14 code size is usually small compared to UES 12 code size, but DES 14 code is very hard to develop because it often includes numerical intensive computations and must be highly optimized. To achieve sufficient optimization, DES 14 is usually written in assembly language using an AAD development technique, making verification and quality control extremely difficult.

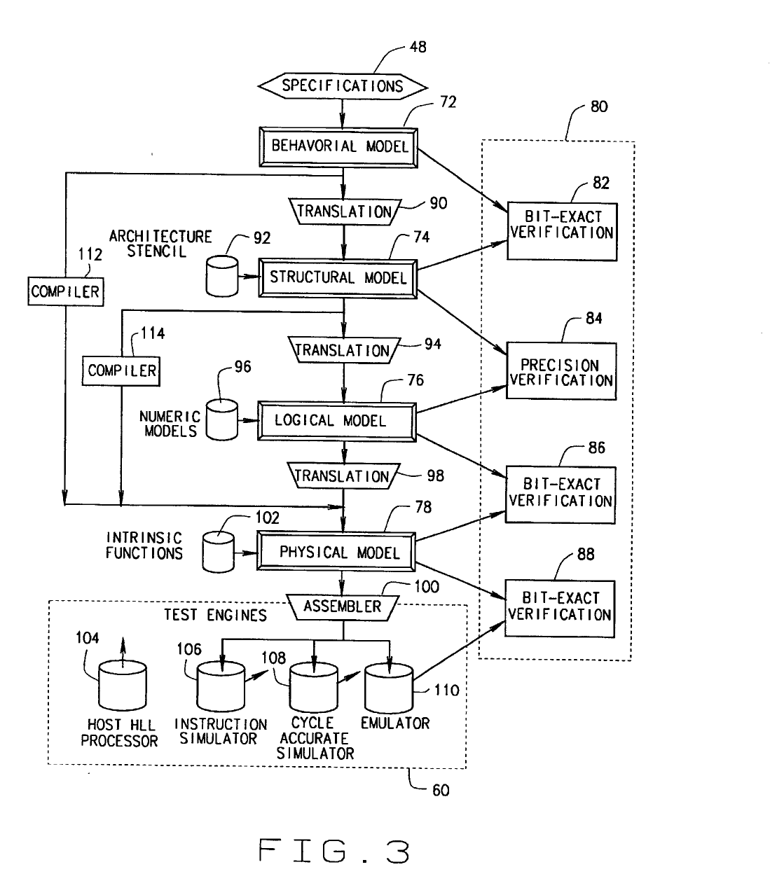

In one embodiment of the present invention and referring to FIG. 3, to improve the productivity of DES generation, a development cycle 70 is systematically divided into four iterative processes each producing a corresponding model 72, 74, 76, 78. A verification procedure 80 is divided into four incremental verification steps 82, 84, 86, 88 that follow the iterative code authoring flow.

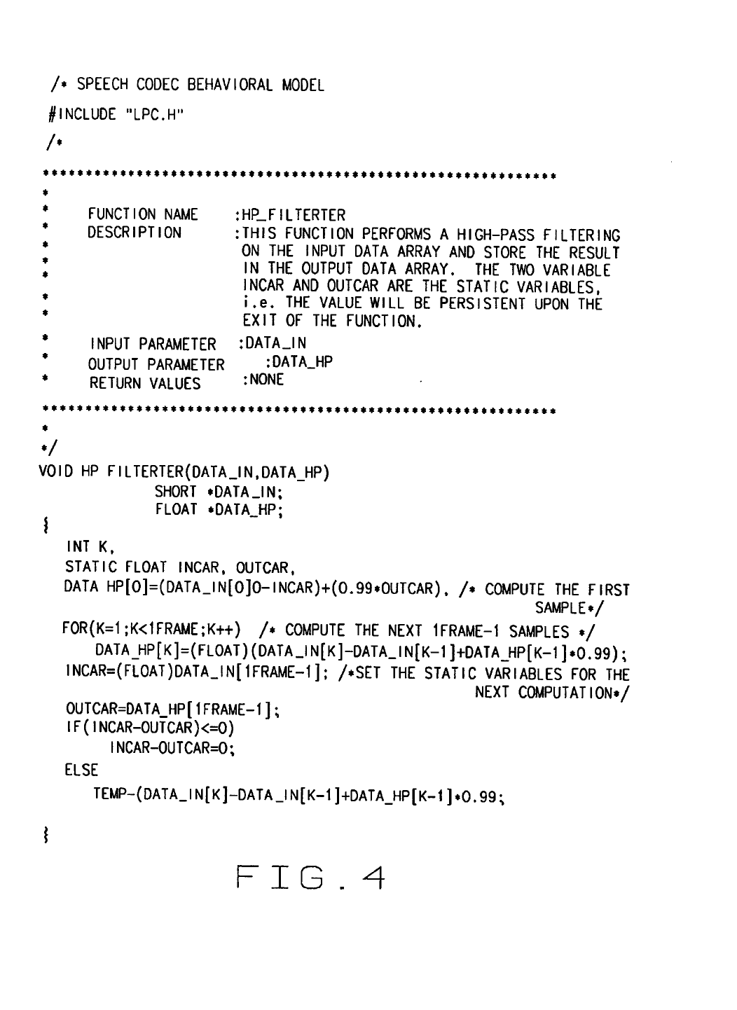

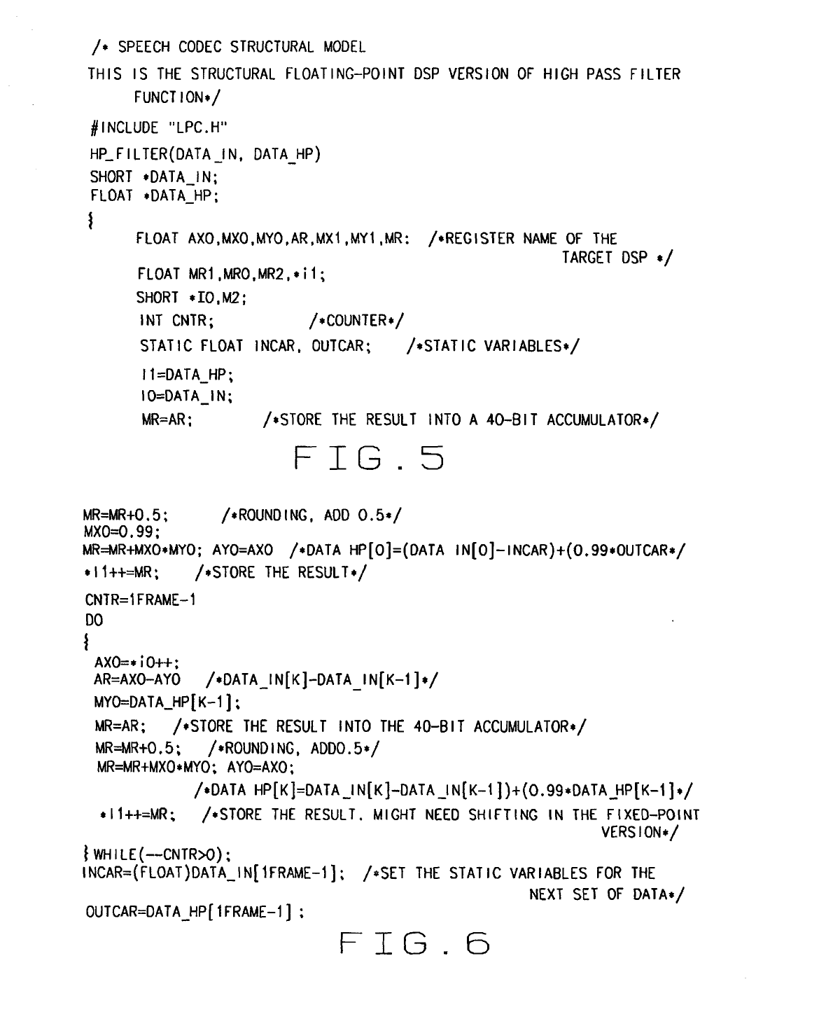

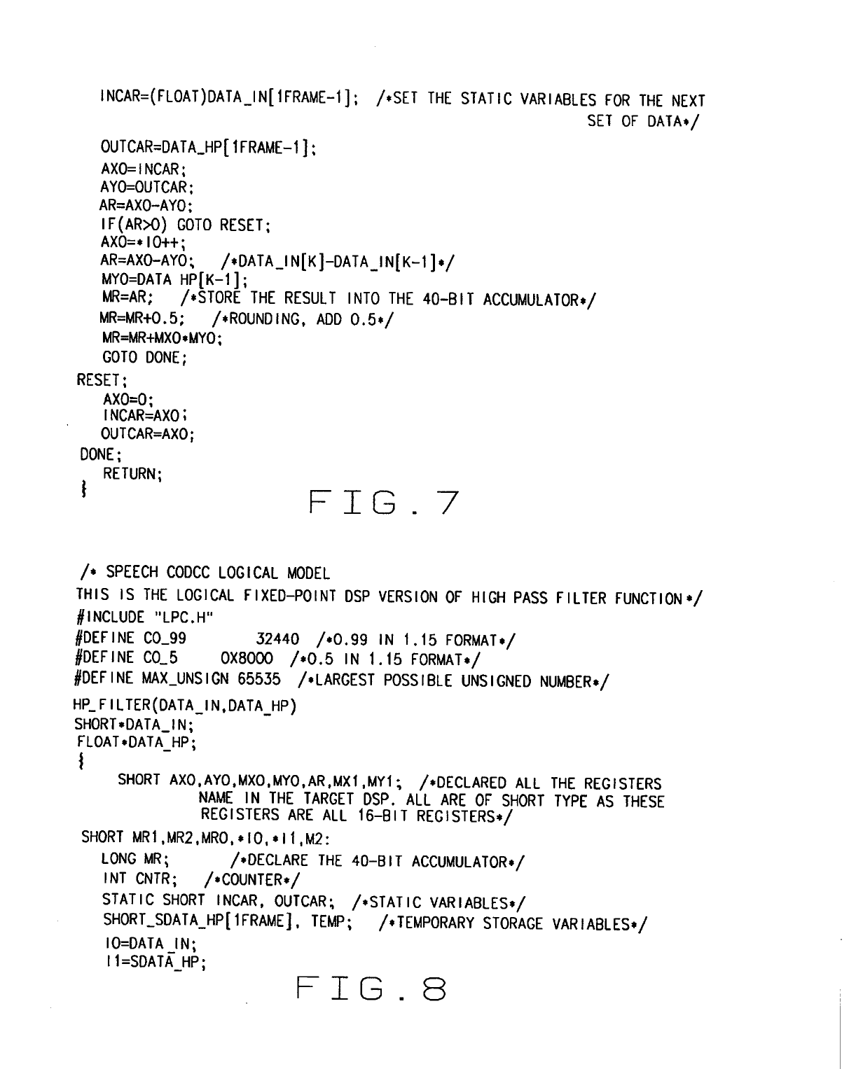

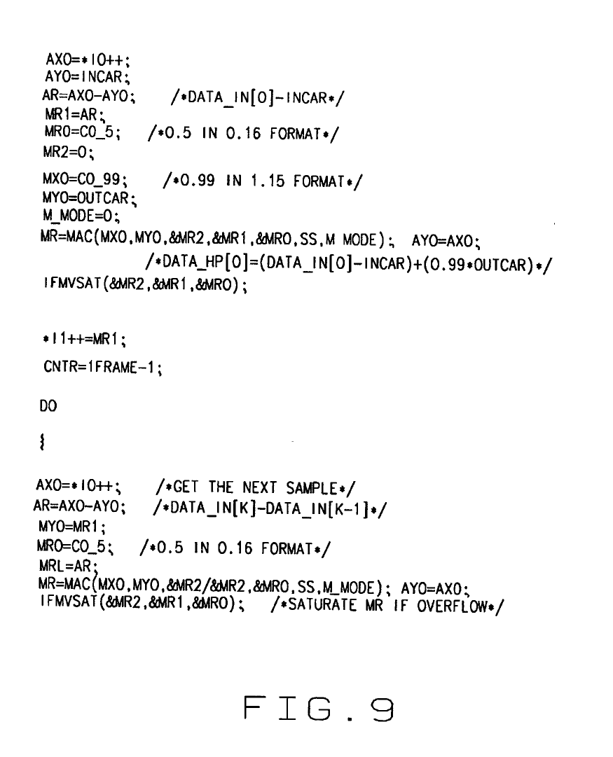

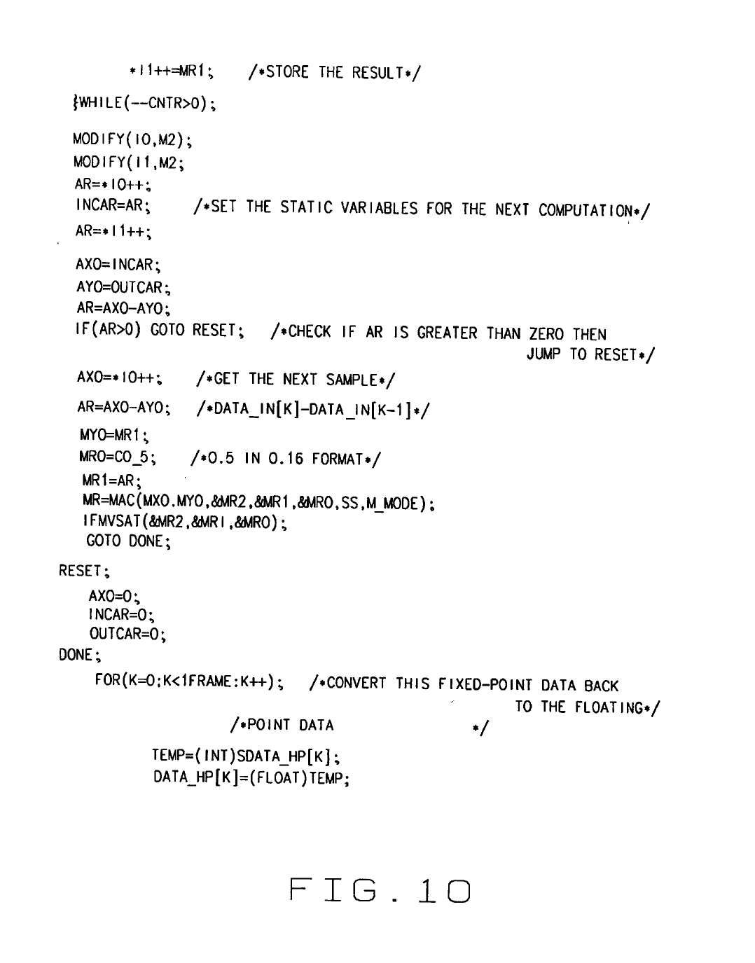

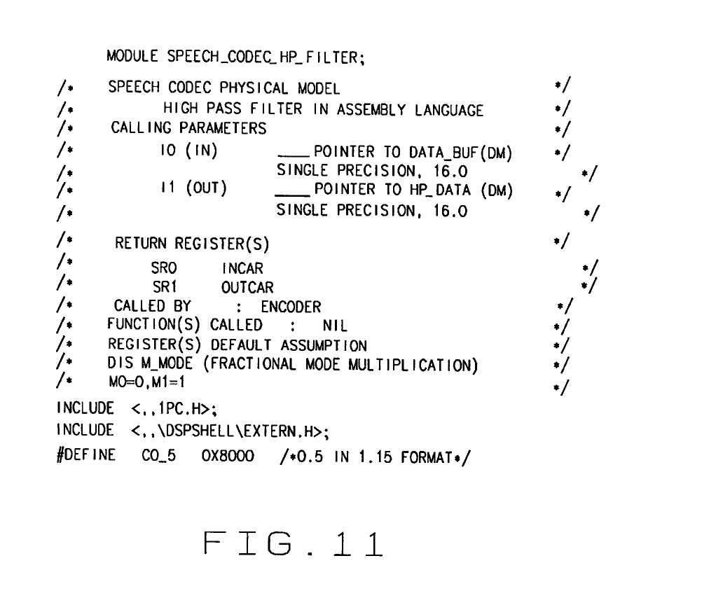

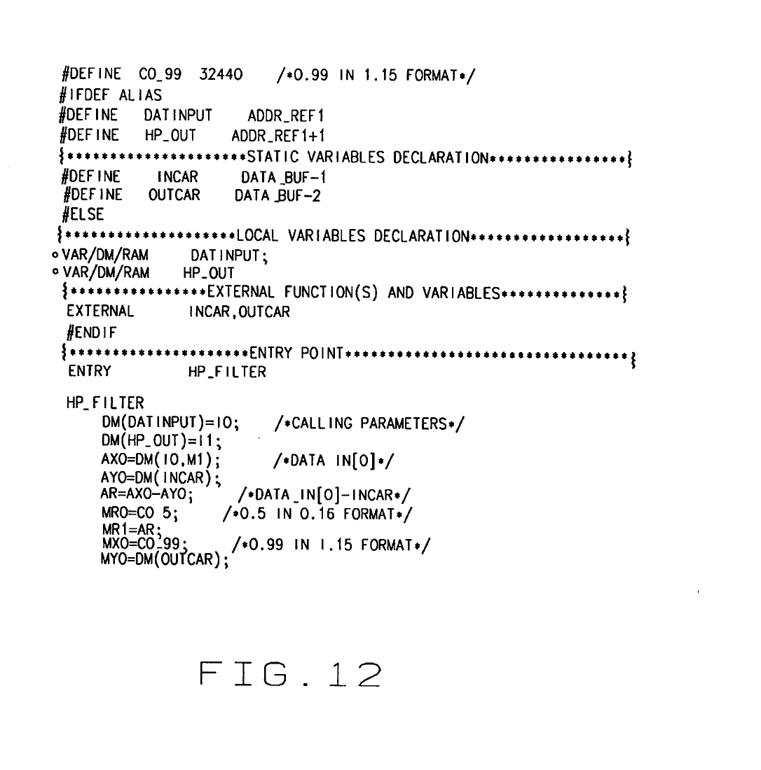

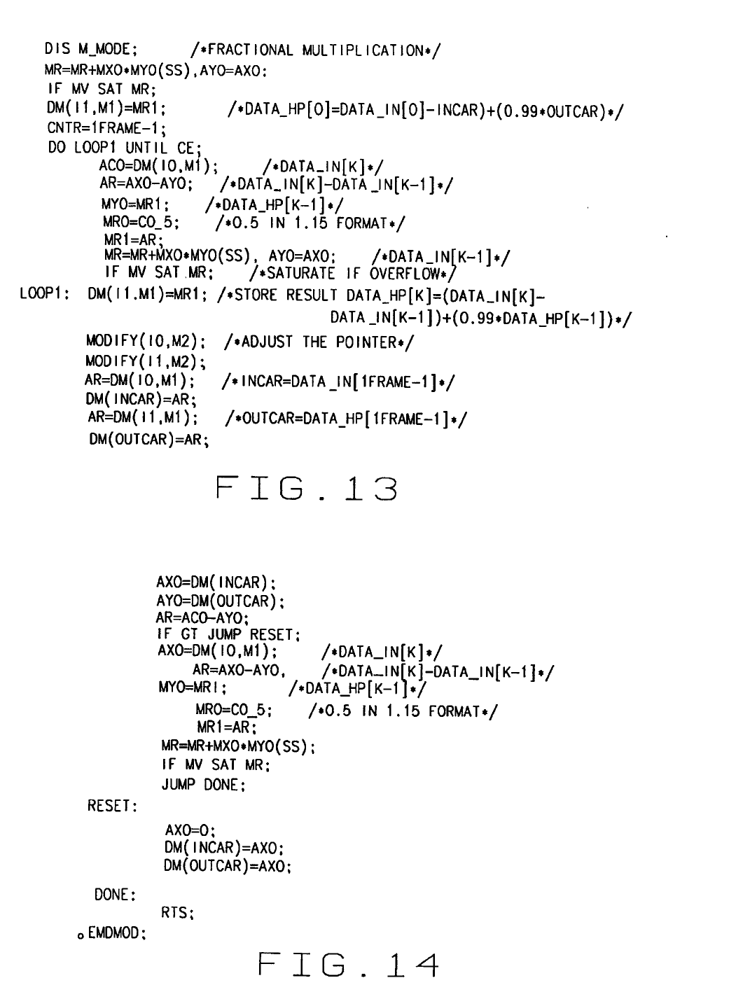

In one embodiment 70 of the present invention, software is authored from a specification 48 in four versions, namely, a behavioral version or model 72 (an example of which is provided in FIG. 4), a structural version or model 74 (an example of which begins in FIG. 5 and continues through FIGS. 6 and 7), a logical version or model 76 (an example of which begins in FIG. 8 and continues through FIGS. 9 and 10) and a physical version or model 78 (an example of which begins in FIG. 11 and continues through FIGS. 12, 13, and 14). Each model 72, 74, 76, and 78 performs the same functionality, but each differs in their coding format. The different coding formats allow the use of incremental verification.

Returning to FIG. 3, behavioral version 72 is based on a behavioral or abstract level module. Behavioral level code is developed from a design concept or a system specification 48 into concise, readable and computable algorithms that can be executed on common computer workstations such as a PC or a Sun workstation (not shown). To generate behavioral version 72 from a specification 48, the following rules are followed:

If specification 48 itself is written in a standard computer language, such as the “C” programming language, use specification 48 as behavioral model 72. Otherwise, using specification 48, write understandable code that avoids obscuring optimizations Write modular code based on the system design, by finding appropriate modules and system partitions, because model 74 will make use of model 72 for its design. Also, use standard variable names. For example, if the code is developed according to a standard document from a standardization body, then use variable names that are use in the standard document. Write concise architecture independent code that does not include target computer-specific features, using a standardized high level language (HLL) such as ANSI-C, without non-standard enhancements. For verification, perform either an objective or subjective confirmation test.

Each model is converted into another model by a translation process. Because each translator handles only an incremental aspect of code authoring, the translators can be made very simple and efficient. Moreover, because the translators handle only small steps, verification is simplified. If an error is found, the scope of the trace-back required is limited. Thus, translation 90 translates behavioral model 72 into a structural model 74, which is an architecture-dependent description. The code for structural model 74 produced by translation 90 matches the target processors architecture, which utilizes an architectural model or stencil 92 of the target processor. Translation 90 is performed using the following rules: Break or combine lines of behavioral model 72 into basic DSP or microprocessor operations to match MAC and/or ALU instruction architecture. Change code as necessary to use only addressing modes supported by the target architecture. In one embodiment, for example, references to a two-dimensional array are changed to reference a one dimensional circular buffer. Use the same register name as intermediate variables. Change all control code into the style of the target processor, so that the control code uses integer operations, looping and addressing pointer computation. Do not make modifications of numeric operations (e.g., truncations and rounding off) that would change the accuracy of results. Increase code efficiency by using and/or developing a set of macros that perform standard algorithms, such as by matching register numbers, MAC and ALU structures and pointer numbers.

Architecture stencil 92 is a pre-existing database containing embedded microprocessor or DSP core architecture information of at least one or more target processors. This information can be used to facilitate production of structural model 74. For example, in one embodiment, this information is used by a translator 90 to perform automatic translation. In another embodiment, the information is used to facilitate manual modeling.

Reference results generated from up-layer models are compared to testing results generated by a model being tested to determine the correctness of the current model. Depending upon the model being tested, the correctness of the reference result and the correctness of the testing results are either verified at the bit level or with “precision verification.” In the latter case, the results do not have to be identical at the bit level, but instead the results are the same within an acceptable or predetermined precision. Precision verification method is more difficult than bit-exact verification, but embodiments of the present invention isolates precision verification as a single task separate from more easily performed tasks and places it in a later development stage. Thus, more skilled resource can be assigned to the more difficult task of precision verification. This isolation also reduces confusion and inefficiency in design by not requiring verification of many tasks at the same time.

Because of the nature of structural model 74, bit exact verification 82 is used. For speech coding type applications, for example, bit-exact verification 82 is a full objective test comparing results from structural model 74 with test vectors generated from behavior model 72. Structure model 72 and behavior model 74 should produce the same result in a bit-by-bit comparison 82.

A translation 94 is performed to produce logical model 76 from structural model 74. Logical model 76 is a precision dependent description in that code generated for logical model 76 has a precision and dynamic range dictated by the target processor's word length. Logical model 76 is important for numerically-intensive algorithm development. It is created by replacing numeric operations with software models 96 of these operation as performed by the target processor or processors. For example, a C language library containing models 96 is used in one embodiment to reflect all limited word length effects, such as saturation, non-biased round-off errors, and other effects of the limited precision of the target processor. Models 76 explicitly take into account irregular word lengths, such as 20, 24, 36, 40, 48, 56 bit cases, depending upon the target DSPs. All accuracy mimics the actual target hardware. The construction of logical model 76 is iterated until an efficient algorithm is found that meets verification criterion. In one embodiment of the present invention, double precision and block floats are used instead of floating-point operations whenever possible. A pipeline register is also used when required to accurately reflect pipeline effects and latencies.

In one embodiment, a pre-existing database of numeric models 96 contains the embedded microprocessor or DSP's numeric characteristics. Database 96 is used in at least one embodiment to assist in building logic model 76. For example, in one embodiment, it is used by translator 94 to perform automatic translation. In another embodiment, it is used to facilitate manual modeling. In one embodiment, database 96 is a numerical model library containing a collection of word-length, saturation and truncation information for at least one or more different processors.

Logical model 76 is verified by precision verification 84 (rather than bit-exact verification) which compares test vector results from logical model 76 to reference results generated from structural model 74. If the structure model uses floating point mathematics, verification 84 may not achieve bit-exact verification. In such an event, a number of design iterations of logical model 76 may be needed to justify a tradeoff between subjective performance and efficiency as measured in MIPS (millions of instructions per second, i.e., speed) of the processor on which logical model 76 is run. If structural model 74 is a fixed point model, then verification 84 should be able to achieve bit exact verification, but as a design choice, efficiency as measured in MIPS can be optimized, instead.

A translation 98 is performed on logical model 76 to produce a physical model 78. Physical model 78 code developed from logical model 76 is actually assembly language code. In one embodiment, code for physical model 78 meets bit exact verification criteria while being able to run in an assembly language tool environment 100. Physical model 78 contains code emphasizing the relationship between linker and memory arrangement and real-time performance. In one embodiment, because logic model 76 uses the same code structure, translation 98 from logical model 76 to physical model 78 is performed by an automatic translator that replaces code in logical model 76 with intrinsic target processor assembly language statements or functions 102. A linker file is created by from the target processor assembly language statements. The final linked executable file is run using an emulator or cycle-accurate simulator. A bit exact verification 86 compares test vector results from physical model 78 to reference results generated from logical model 76.

In one embodiment, a pre-existing database of intrinsic functions 102 contains embedded microprocessor or DSP's special physical instruction models. Each function corresponds to an instruction in a target processor. In at least one embodiment of the present invention, database 102 is used to assist in building physical model 78. For example, it is used by a translator 98 to assist in automatic translation or is used to facilitate manual modeling. Also in one embodiment, intrinsic function database or library 102 contains a collection of functions configured to simulate assembly language instructions for at least one or more processors.

Assembler 116 is piece of software that is used to convert assembly language (i.e., physical model) code to binary machine code. The machine code can run in the target processor. In one embodiment of the present invention, the machine code is the code provided to a chip fabrication plant for directly fabricating firmware to a hard processor core platform. Thus, in one embodiment of the present invention, the physical model is a coded version (in assembly language, for example) of the deep-embedded software itself.

Test engines or platforms 60 are executable hardware and/or software that run models 72, 74, 76, and 78 and produce results according to input test signals. Host high-level language (HLL) processor 104 is a host computer that runs HLL code through a native compiler, for example, an IBM PC host using a Microsoft C/C++ compiler, or a Sun Workstation host using a GNU-CC compiler. Test engines or platforms 106, 108 and 110 are used to run target processor code for testing physical model 78. These test engines include an instruction set simulator (ISS) 106. ISS 106 runs assembled binary code models rapidly and efficiently because it is not required to strictly adhere to the timing of the target processor. A cycle-accurate simulator 108 runs the same code simulating accurate timing of the target processor, and therefore is slower. Emulator 110 includes actual hardware of the target processor, and so performs tests of the physical model in “real time,” i.e., with the same timing as would the target processor. It is an advantage of this embodiment of the present invention that the verification effort, which comprises the verification of three separate models, is moved to a common host platform that is very easy to use and readily available. The ability to use such platforms increases productivity.

When two or three translators are cascaded together, they become a cross-compiler. For example, cross-compiler 112 translates behavior model 72 into physical model 78. Also for example, cross-compiler 114 translates structural model 74 into physical model 78. In one embodiment of the present invention, translation processes use computer software or automatic translators such as cross-compilers 112 and 114. However, in another embodiment, manual translation or semiautomatic translation (i.e., manual translation with some computer assistance less than a full automatic compilation) is used. In embodiments using manual translation, productivity is still improved relative to known techniques, provided that software engineers follow a hierarchical layer structure and modeling technique of the present invention to allow incremental verification to be used.

Compilers are computer software programs that convert one language (e.g., a high-level language) to a target language (e.g., an assembly language of the target processor). Cross compilers 112 and 114 used in one embodiment of the present invention convert high-level language code to an assembly language of the target processor rather than the processor being used to execute the cross compiler program. Cross compilers are used in one embodiment of the present invention for automatic code authoring to support up-embedded software development and for fast prototyping purpose.

Embodiments of the present invention allow more engineers to be deployed in development of firmware and deep embedded software by breaking the development process into a standard, multiple-step process. Each engineer can be assigned to a particular portion of the process. Use of embodiments of the present invention results in improvements in the productivity of software engineers and allows formal control of output quality. Factories using embodiments of the present invention are able to increase production of highly sophisticated deep-embedded software and firmware. Factories set up in this manner can be arranged for pipeline or parallel flow of work product. The software and firmware products produced can be licensed to an SoC chip integrator. If a firmware factory directly engages a chip fabrication plant, a “designless” chip manufacture model of the present invention can be realized. “Designless” chip manufacturing is a process in which a chip manufacturer is not required to go through a circuit design stage, but rather directly fabricates firmware to certain hard processor core platforms. The “designless” mode of operation is analogous to two other models of chip production, namely, the “fabless” model and the “chipless” model.

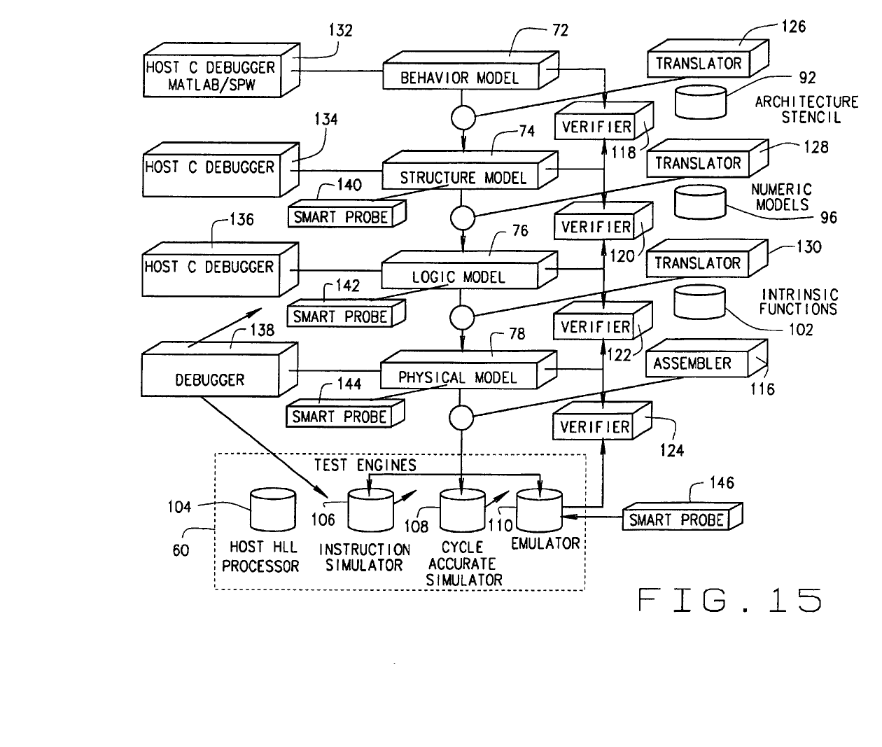

One embodiment of the present invention is an EDA (Electronics Design Automation) system or design tool. For example, development tools are deployed to replace a manual process, as shown in FIG. 15. Verification is done using “verifier” tools 118, 120, 122, and 124. Translation is performed by translators 126, 128, and 130. Three host HLL debuggers 132, 134, and 136 and a low-level assembly and physical language hybrid debugger 138 are used for debugging purposes for various layers. Smart probes 140, 142, 144, and 146 are used for signal detection and for watch points, and are placed in various layers to trace errors. The use of such tools can significantly improve firmware development productivity.

Debuggers 132, 134, and 136 comprise computer software that assists engineers in viewing code execution details and in correcting errors in the executing code, and in one embodiment are “host” C debuggers. A host C debugger is a native debugger that accompanies a C language compiler. Because host C debuggers are among the most widely used debuggers, users do not have a steep learning curve to surmount to learn debuggers based on host C debuggers. In one embodiment of the present invention, most of the DES development work (i.e., the behavioral, structure, and logical models) is moved into a host C environment, so that the most time consuming parts of the debugging effort become much easier. This debugging technique contrasts significantly with CAO and AAD methods, because both of these methods require the use of dedicated debuggers. More specifically, CAO requires a dedicated C cross-compiler and debugger that are supplied only with a particular target processor being used. AAD uses a dedicated assembler and debugger tool that is also specific to a target processor.

Low level assembly and physical language hybrid debugger (“hybrid debugger”) 138 comprises computer software that is configured to assist engineers to view code execution details and correct errors. Physical model 78 is executed on target processor test engine 60 comprising simulators 106 and 108 and emulator 110. Therefore, hybrid debugger 138 dedicated to the target processor is provided. Embodiments of the invention are “debugger independent,” in that a user may chose any physical debugger he or she prefers to debug the physical model software. However, when the target processor is changed, hybrid debugger 138 is also changed, requiring users to spend some time to learn the new tool. Therefore, a universal physical debugger can be employed as hybrid debugger 138. A universal physical debugger is closely integrated to the development flow, and supports all processors in essentially the same way. Another feature of a universal physical debugger is that it can bridge logical model 76 and physical model 78 to trace physical model 78 errors back to the logical model 76 smoothly through translator 130. In addition, a universal physical debugger can refer to architectural stencil or model 92, numeric model 96 and intrinsic functions 102 to provide more and better debugging capability than traditional assembly language debuggers.

Smart probes 140, 142, 144, and 146 are watch points embedded in code that dynamically display and scope signal behavior. Not all embodiments of the present invention use smart probes. However, in embodiments designed as EDA tools, smart probes can be utilized to enhance productivity. For example, smart probes 140, 142, and 144 are host probe threads that run in the background. Smart probe 146 runs integrated with a universal physical debugger, when such a debugger is used as hybrid debugger 138.

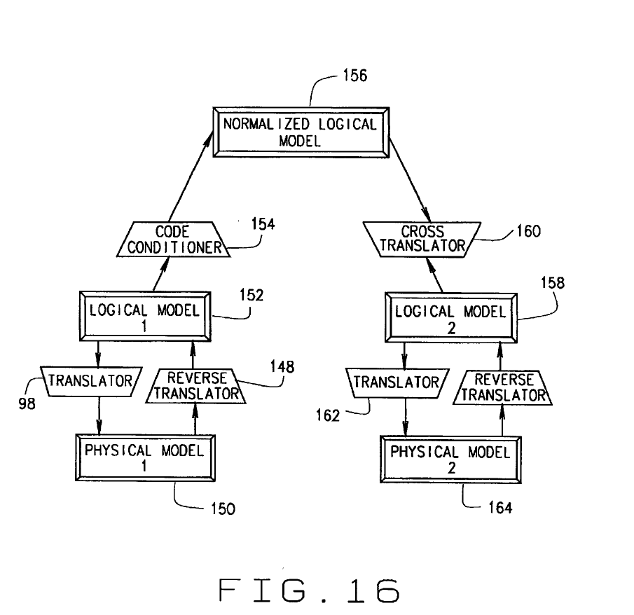

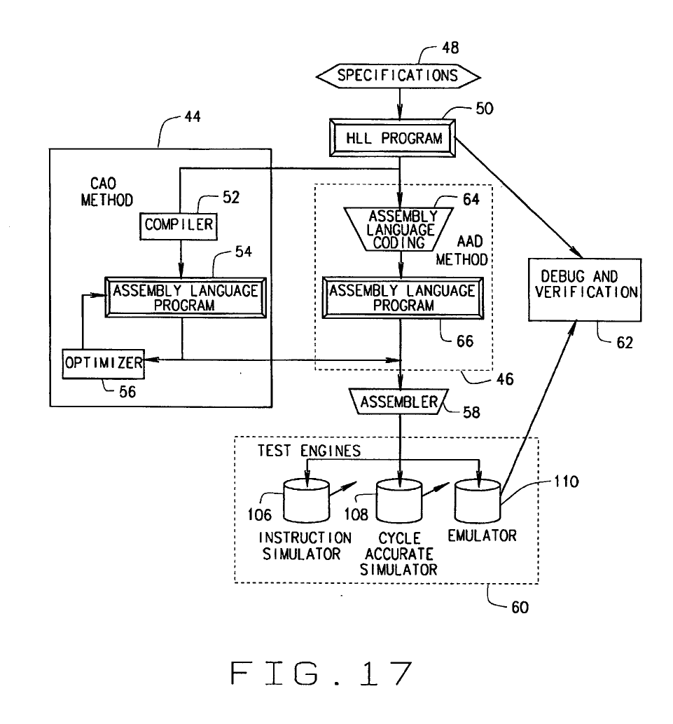

Because deep embedded software, such as DSP firmware, is written primarily in assembly language, it is difficult to port such software from one architecture to another. This is especially the case for DSP code, because of its highly optimized and numerical intensive nature. However, use of embodiments of the present invention make it easier to systematically transfer assembly language code to another processor. For example, in one embodiment of the present invention and referring to FIG. 16, code targeted to a first processor is morphed to code targeted to a second, different type of processor in the following manner:

Reverse translator 148 is used to translate assembly code 150 targeted to a first processor into logical model 152. Logical model 152 is written in a high-level language, such as standard “C” language, with processor architecture information, thus removing assembly language directives and memory location information from the code.

Code conditioner 154 is used to convert logical model 152 into normalized logical model 156, which is minimum superset model of both processor logical models 152 and 158.

From normalized logical model 156, cross translator 160 is used to translate code 156 to a second logical model 158.

From second logical model 158, second translator 162 is used to translate to second physical model 164, i.e. the assembly language code of the second processor.

Although apparently tedious, embodiments of the present invention for porting code provide an incremental porting strategy. Thus, the porting methods are easy to perform and can be conducted as part of a firmware factory flow. In addition, human intervention and optimization can be readily applied in any intermediate steps, if needed to ensure proper optimization and correctness.

Method embodiments of the present invention are applicable to both manual and automated software development, and combinations thereof. Thus, various process steps are performed manually by one or more software engineers or technicians in various embodiments of the present invention. None, one or more of the authoring or debugging steps are performed manually, and the remainder performed automatically after being started, without intervention, as by automatic compilation or assembly. (A step that is performed with the aid of computers, software, and/or debugging tools, but which is not completed automatically, without intervention, after having been started, is considered as being performed “manually.”)

While the invention has been described in terms of various specific embodiments, those skilled in the art will recognize that the invention can be practiced with modification within the spirit and scope of the claims.

What is claimed is:

1. A method for producing deep embedded software suitable for a target processor, said method comprising the steps of:
authoring a behavioral model from a specification;
authoring a structural model using the behavioral model;
authoring a logical model using the structural model; and
authoring a physical model using the logical model.

2. A method in accordance with claim 1 further comprising the step of performing a confirmation test of the behavioral model using a test platform.

3. A method in accordance with claim 2, wherein said step of authoring a structural model comprises the step of translating the behavioral model into a structural model using an architecture-dependent description, so that the structural model matches an architecture of the target processor.

4. A method in accordance with claim 3 further comprising the step of testing the structural model using the same test platform used to test the behavioral model.

5. A method in accordance with claim 3 wherein said step of translating the behavioral model into a structural model using an architecture dependent description comprises the step of changing code in the behavioral model to use only addressing modes supported by the architecture of the target processor.

6. A method in accordance with claim 5 wherein said step of translating the behavioral model into a structural model using an architecture dependent description further comprises the step of changing references to a two-dimensional array to references to a one dimensional circular buffer.

7. A method in accordance with claim 5 wherein said step of translating the behavioral model into a structural model using an architecture dependent description further comprises the step of modifying control code to use integer operations, looping, and addressing pointer computation.

8. A method in accordance with claim 3 wherein said step of translating the behavioral model into a structural model using an architecture-dependent description utilizes a pre-existing database containing embedded microprocessor or DSP core architecture information.

9. A method in accordance with claim 3 further comprising the steps of producing test results using the structural model, producing test results using the behavioral model, and comparing the test results produced using the structural model with the test results produced using the behavioral model using bit exact verification.

10. A method in accordance with claim 1 wherein the logical model has a precision and dynamic range selected in accordance with a word length of the target processor.

11. A method in accordance with claim 1 further comprising the step of testing the logical model using the same test platform used to test the behavioral model.

12. A method in accordance with claim 11 wherein said step of authoring a logical model comprises the step of utilizing a library reflecting limited word length effects of limited precision of the target processor.

13. A method in accordance with claim 11 wherein said step of authoring a logical model further comprises automatically translating the structural model into the logical model utilizing a pre-existing database of numeric models.

14. A method in accordance with claim 11 further comprising the step of comparing test results from the structural model with test results from the logical model utilizing precision verification.

15. A method in accordance with claim 11 wherein the logical model is a fixed-point model, and further comprising the step of comparing test results from the structural model with test results from the logical model utilizing bit-exact verification.

16. A method in accordance with claim 1 wherein said step of authoring a physical model using the logical model comprises automatically translating the logical model into the physical model utilizing an automatic translator that replaces code in the logical model with intrinsic target processor assembly language statements or functions.

17. A method in accordance with claim 16 wherein said step of automatically translating the logical model into the physical model further utilizes a pre-existing database of intrinsic functions.

18. A method in accordance with claim 16 further comprising the step of comparing test results generated from the logical model with test results generated from the physical model utilizing bit exact verification.

19. A method in accordance with claim 1 further comprising the steps of assembling and emulating the physical model, and performing a bit-exact verification of test results from the emulation with test results from the physical model.

20. A method in accordance with claim 1, further comprising the steps of:
comparing test results from the structural model with test results from the behavioral model utilizing bit exact verification;
comparing test results from the logical model with test results from the structural model utilizing precision verification; and
comparing test results from the physical model with test results from the logical model utilizing bit-exact verification.

21. A method in accordance with claim 1 and further comprising the step of providing the deep embedded software to a chip manufacturer for fabricating firmware to a hard processor core platform.

22. An electronic design automation (EDA) system design tool comprising:
a translator configured to translate a behavioral model into a structural model, a translator configured to translate the structural model into a logical model, and a translator configured to translate the logical model into a physical model;
a debugger configured to debug the behavioral model, a debugger configured to debug the structural model, a debugger configured to debug the logical model, and a debugger configured to debug the physical model; and
a verifier configured to compare test results from the behavioral model with test results from the structural model, a verifier configured to compare test results from the logical model with test results from the structural model, and a verifier configured to compare test results from the physical model with test results from the logical model.

23. A system design tool in accordance with claim 22 wherein said debuggers configured to debug the behavioral model, the structural model, and the logical model are host C debuggers.

24. A system design tool in accordance with claim 23 wherein said debugger configured to debug the physical model is a hybrid debugger.

25. A system design tool in accordance with claim 23 wherein said debugger configured to debug the physical model is a universal physical debugger.

26. A system design tool in accordance with claim 22 further comprising an architecture stencil containing a database of architectural information for a plurality of processors.

27. A system design tool in accordance with claim 22 further comprising a numerical library containing a collection of word-length, saturation, and truncation information for a plurality of processors.

28. A system design tool in accordance with claim 22 further comprising an intrinsic function library containing a collection of functions configured to simulate assembly language instructions for a plurality of processors.

29. A system design tool in accordance with claim 22 further comprising a test engine including an instruction set simulator, a cycle accurate simulator and an emulator, said test engine configured to process a physical model.

30. A method for morphing assembly code targeted for a first processor into code targeted to a second processor comprising the steps of:
reverse translating the assembly code targeted for the first processor into a first logical model;
converting the first logical model into a normalized logical model that is a minimum superset model of logical models of both the first processor and the second processor;
cross-translating the normalized logical model into a second logical model;
translating the second logical model into assembly language code of the second processor.
